(19) United States
(12) Patent Application Publication
(10) Pub. No.: US 2015/0289314 A1
(43) Pub. Date: Oct. 8, 2015

(54) TUNE-AWAY FOR MULTI-SIM MULTI-STANDBY DEVICES

(71) Applicant: QUALCOMM Incorporated, San Diego, CA (US)

(72) Inventors: Ming Yang, San Diego, CA (US); Qingxin Chen, Del Mar, CA (US); Tom Chin, San Diego, CA (US)

(73) Assignee: QUALCOMM Incorporated, San Diego, CA (US)

(21) Appl. No.: 14/246,795

(22) Filed: Apr. 7, 2014

(51) Int. Cl. H04W 88/06; H04J 3/17

(52) U.S. Cl. CPC H04W 88/06; H04J 3/17; H04W 36/14

(57) ABSTRACT

A multi-subscriber identity module (SIM) multi-standby user equipment (UE) improves recovery of an original operation of a first radio access technology (RAT) when the UE tunes away from the first RAT. In some instances, the UE communicates with the first RAT on a transmit chain and a receive chain and then tunes to a second RAT on the receive chain to monitor downlink communications or activities of the second RAT. The UE transmits on the first RAT over the transmit chain, while tuned to the second RAT. Thus, the UE continues to perform uplink transmission when the UE tunes away, which allows a base station of the first RAT to track the UE for downlink beam-forming.

### BACKGROUND

1. Field

Aspects of the present disclosure relate generally to wireless communication systems, and more particularly, to a tune away method for multi-subscriber identity module (SIM) multi-standby devices in a cellular network.

2. Background

Wireless communication networks are widely deployed to provide various communication services such as telephony, video, data, messaging, broadcasts, and so on. Such networks, which are usually multiple access networks, support communications for multiple users by sharing the available network resources. One example of such a network is the Universal Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). For example, China is pursuing TD-SCDMA as the underlying air interface in the UTRAN architecture with its existing GSM infrastructure as the core network. The UMTS also supports enhanced 3G data communications protocols, such as High Speed Packet Access (HSPA), which provides higher data transfer speeds and capacity to associated UMTS networks. HSPA is a collection of two mobile telephony protocols, High Speed Downlink Packet Access (HSDPA) and High Speed Uplink Packet Access (HSUPA) that extends and improves the performance of existing wideband protocols.

As the demand for mobile broadband access continues to increase, research and development continue to advance the UMTS technologies not only to meet the growing demand for mobile broadband access, but to advance and enhance the user experience with mobile communications.

### SUMMARY

In one aspect, a method of wireless communication with a multi-subscriber identity module (SIM), multi-standby user equipment is disclosed. The method includes communicating with a time division based first radio access technology (RAT) using a transmit chain and a receive chain. The method also includes tuning the receive chain to a second RAT and/or frequency to monitor downlink communications. The method also includes transmitting on the first RAT with the transmit chain, while tuned to the second RAT on the receive chain, to enable a base station to estimate uplink timing of the first RAT and a corresponding downlink beam based at least in part on the uplink transmission from the UE.

Another aspect discloses an apparatus for wireless communication with a multi-subscriber identity module (SIM), multi-standby user equipment. The apparatus includes means for communicating with a time division based first radio access technology (RAT) using a transmit chain and a receive chain. The apparatus also includes means for tuning the receive chain to a second RAT and/or frequency to monitor downlink communications. The apparatus also includes means for transmitting on the first RAT with the transmit chain, while tuned to the second RAT on the receive chain, to enable a base station to estimate uplink timing of the first RAT and a corresponding downlink beam based at least in part on the uplink transmission from the UE.

In another aspect, a computer program product for wireless communications in a wireless network having a non-transitory computer-readable medium is disclosed. The computer readable medium has non-transitory program code recorded thereon which, when executed by the processor(s), causes the processor(s) to perform operations of communicating with a time division based first radio access technology (RAT) using a transmit chain and a receive chain. The operations also include tuning the receive chain to a second RAT and/or frequency to monitor downlink communications. The operations also include transmitting on the first RAT with the transmit chain, while tuned to the second RAT on the receive chain, to enable a base station to estimate uplink timing of the first RAT and a corresponding downlink beam based at least in part on the uplink transmission from the UE.

Another aspect discloses an apparatus for wireless communication having a memory and at least one processor coupled to the memory. The processor(s) is configured to communicate with a time division based first radio access technology (RAT) using a transmit chain and a receive chain. The processor(s) is also configured to tune the receive chain to a second RAT and/or frequency to monitor downlink communications. The processor(s) is also configured to transmit on the first RAT with the transmit chain, while tuned to the second RAT on the receive chain, to enable a base station to estimate uplink timing of the first RAT and a corresponding downlink beam based at least in part on the uplink transmission from the UE.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 is a block diagram conceptually illustrating an example of a telecommunications system.

FIG. 2 is a block diagram conceptually illustrating an example of a frame structure in a telecommunications system.

FIG. 3 is a block diagram conceptually illustrating an example of a node B in communication with a UE in a telecommunications system.

FIG. 4 illustrates network coverage areas according to aspects of the present disclosure.

FIG. 5 is a call flow diagram of a tune away procedure for a multi-subscriber identity module (SIM) multi-standby device according to aspects of the present disclosure.

FIG. 6 is a block diagram illustrating an tune-away method for a multi-SIM multi-standby device according to aspects of the present disclosure.

FIG. 7 is a diagram illustrating an example of a hardware implementation for an apparatus employing a processing system according to one aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

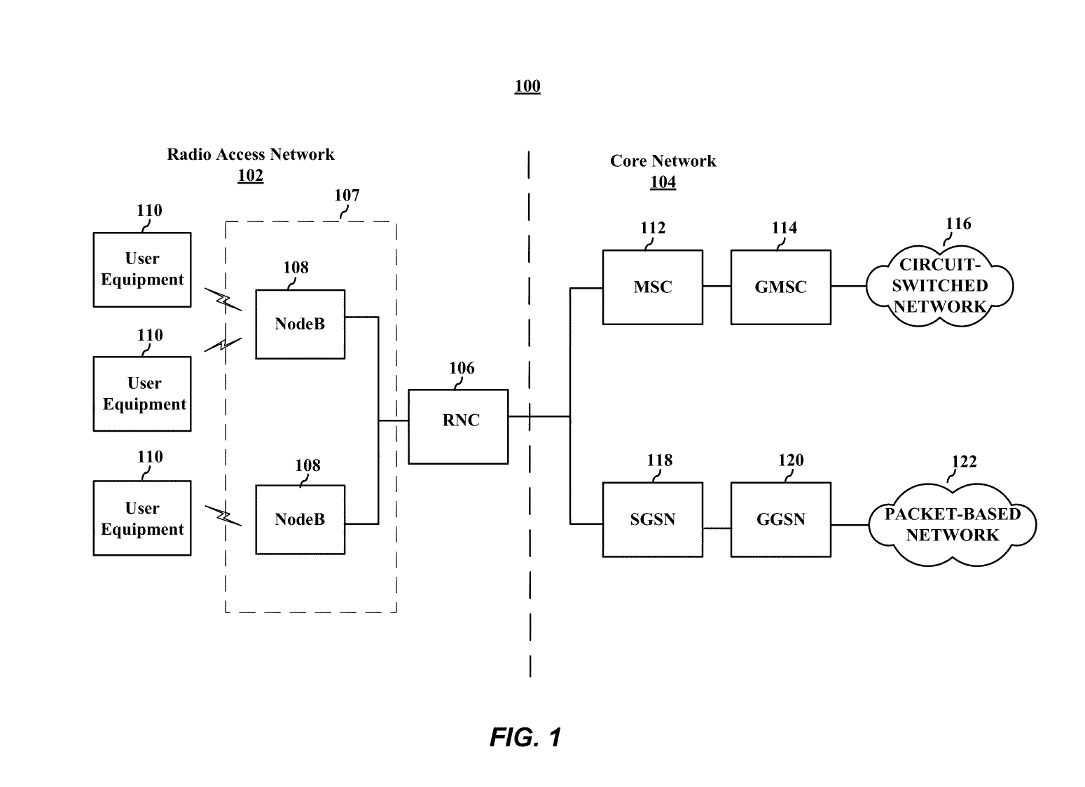

Turning now to FIG. 1, a block diagram is shown illustrating an example of a telecommunications system 100. The various concepts presented throughout this disclosure may be implemented across a broad variety of telecommunication systems, network architectures, and communication standards. By way of example and without limitation, the aspects of the present disclosure illustrated in FIG. 1 are presented with reference to a UMTS system employing a TD-SCDMA standard. In this example, the UMTS system includes a (radio access network) RAN 102 (e.g., UTRAN) that provides various wireless services including telephony, video, data, messaging, broadcasts, and/or other services. The RAN 102 may be divided into a number of Radio Network Subsystems (RNSs) such as an RNS 107, each controlled by a Radio Network Controller (RNC) such as an RNC 106. For clarity, only the RNC 106 and the RNS 107 are shown; however, the RAN 102 may include any number of RNCs and RNSs in addition to the RNC 106 and RNS 107. The RNC 106 is an apparatus responsible for, among other things, assigning, reconfiguring and releasing radio resources within the RNS 107. The RNC 106 may be interconnected to other RNCs (not shown) in the RAN 102 through various types of interfaces such as a direct physical connection, a virtual network, or the like, using any suitable transport network.

The geographic region covered by the RNS 107 may be divided into a number of cells, with a radio transceiver apparatus serving each cell. A radio transceiver apparatus is commonly referred to as a node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two node Bs 108 are shown; however, the RNS 107 may include any number of wireless node Bs. The node Bs 108 provide wireless access points to a core network 104 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 110 are shown in communication with the node Bs 108. The downlink (DL), also called the forward link, refers to the communication link from a node B to a UE, and the uplink (UL), also called the reverse link, refers to the communication link from a UE to a node B.

The core network 104, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 104 supports circuit-switched services with a mobile switching center (MSC) 112 and a gateway MSC (GMSC) 114. One or more RNCs, such as the RNC 106, may be connected to the MSC 112. The MSC 112 is an apparatus that controls call setup, call routing, and UE mobility functions. The MSC 112 also includes a visitor location register (VLR) (not shown) that contains subscriber-related information for the duration that a UE is in the coverage area of the MSC 112. The GMSC 114 provides a gateway through the MSC 112 for the UE to access a circuit-switched network 116. The GMSC 114 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 114 queries the HLR to determine the UE's location and forwards the call to the particular MSC serving that location.

The core network 104 also supports packet-data services with a serving GPRS support node (SGSN) 118 and a gateway GPRS support node (GGSN) 120. GPRS, which stands for General Packet Radio Service, is designed to provide packet-data services at speeds higher than those available with standard GSM circuit-switched data services. The GGSN 120 provides a connection for the RAN 102 to a packet-based network 122. The packet-based network 122 may be the Internet, a private data network, or some other suitable packet-based network. The primary function of the GGSN 120 is to provide the UEs 110 with packet-based network connectivity. Data packets are transferred between the GGSN 120 and the UEs 110 through the SGSN 118, which performs primarily the same functions in the packet-based domain as the MSC 112 performs in the circuit-switched domain.

The UMTS air interface is a spread spectrum Direct-Sequence Code Division Multiple Access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a node B 108 and a UE 110, but divides uplink and downlink transmissions into different time slots in the carrier.

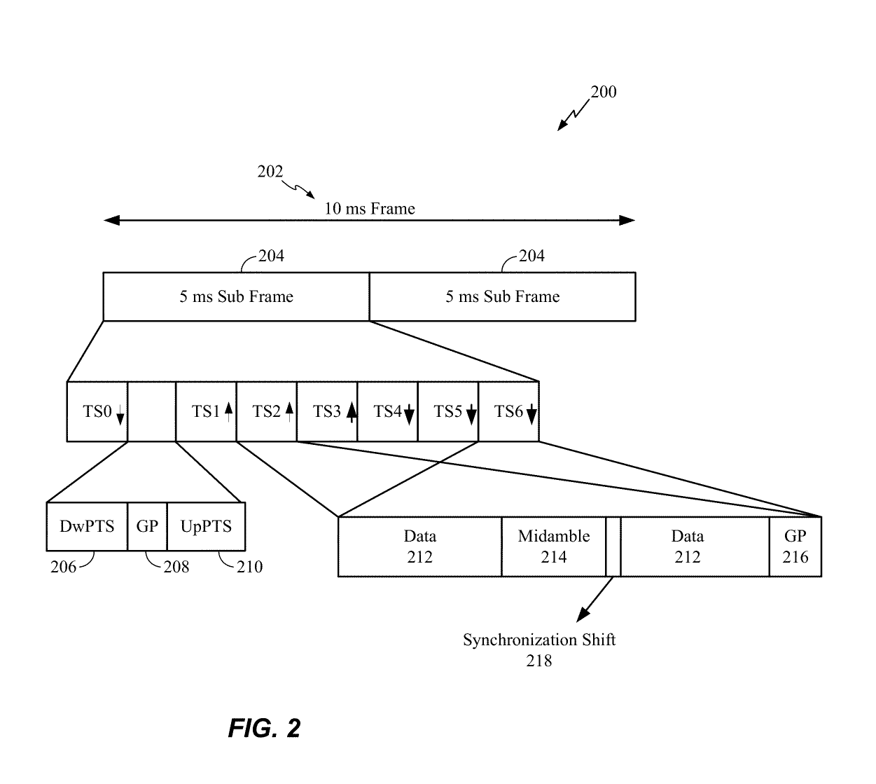

FIG. 2 shows a frame structure 200 for a TD-SCDMA carrier. The TD-SCDMA carrier, as illustrated, has a frame 202 that is 10 ms in length. The chip rate in TD-SCDMA is 1.28 Mcps. The frame 202 has two 5 ms subframes 204, and each of the subframes 204 includes seven time slots, TS0 through TS6. The first time slot, TS0, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A downlink pilot time slot (DwPTS) 206, a guard period (GP) 208, and an uplink pilot time slot (UpPTS) 210 (also known as the uplink pilot channel (UpPCH)) are located between TS0 and TS1. Each time slot, TS0-TS6, may allow data transmission multiplexed on a maximum of 16 code channels. Data transmission on a code channel includes two data portions 212 (each with a length of 352 chips) separated by a midamble 214 (with a length of 144 chips) and followed by a guard period (GP) 216 (with a length of 16 chips). The midamble 214 may be used for features, such as channel estimation, while the guard period 216 may be used to avoid inter-burst interference. Also transmitted in the data portion is some Layer 1 control information, including Synchronization Shift (SS) bits 218. Synchronization Shift bits 218 only appear in the second part of the data portion. The Synchronization Shift bits 218 immediately following the midamble can indicate three cases: decrease shift, increase shift, or do nothing in the upload transmit timing. The positions of the SS bits 218 are not generally used during uplink communications.

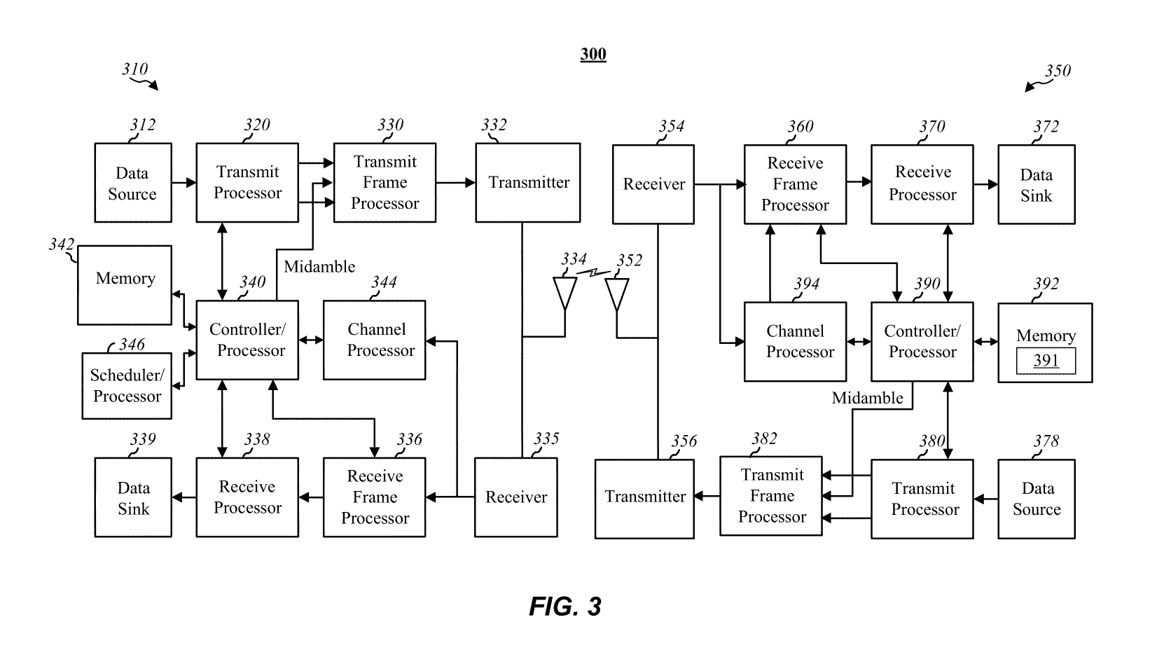

FIG. 3 is a block diagram of a node B 310 in communication with a UE 350 in a RAN 300, where the RAN 300 may be the RAN 102 in FIG. 1, the node B 310 may be the node B 108 in FIG. 1, and the UE 350 may be the UE 110 in FIG. 1. In the downlink communication, a transmit processor 320 may receive data from a data source 312 and control signals from a controller/processor 340. The transmit processor 320 provides various signal processing functions for the data and control signals, as well as reference signals (e.g., pilot signals). For example, the transmit processor 320 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 344 may be used by a controller/processor 340 to determine the coding, modulation, spreading, and/or scrambling schemes for the transmit processor 320. These channel estimates may be derived from a reference signal transmitted by the UE 350 or from feedback contained in the midamble 214 (FIG. 2) from the UE 350. The symbols generated by the transmit processor 320 are provided to a transmit frame processor 330 to create a frame structure. The transmit frame processor 330 creates this frame structure by multiplexing the symbols with a midamble 214 (FIG. 2) from the controller/processor 340, resulting in a series of frames. The frames are then provided to a transmitter 332, which provides various signal conditioning functions including amplifying, filtering, and modulating the frames onto a carrier for downlink transmission over the wireless medium through smart antennas 334. The smart antennas 334 may be implemented with beam steering bidirectional adaptive antenna arrays or other similar beam technologies.

At the UE 350, a receiver 354 receives the downlink transmission through an antenna 352 and processes the transmission to recover the information modulated onto the carrier. The information recovered by the receiver 354 is provided to a receive frame processor 360, which parses each frame, and provides the midamble 214 (FIG. 2) to a channel processor 394 and the data, control, and reference signals to a receive processor 370. The receive processor 370 then performs the inverse of the processing performed by the transmit processor 320 in the node B 310. More specifically, the receive processor 370 descrambles and despreads the symbols, and then determines the most likely signal constellation points transmitted by the node B 310 based on the modulation scheme. These soft decisions may be based on channel estimates computed by the channel processor 394. The soft decisions are then decoded and deinterleaved to recover the data, control, and reference signals. The CRC codes are then checked to determine whether the frames were successfully decoded. The data carried by the successfully decoded frames will then be provided to a data sink 372, which represents applications running in the UE 350 and/or various user interfaces (e.g., display). Control signals carried by successfully decoded frames will be provided to a controller/processor 390. When frames are unsuccessfully decoded by the receiver processor 370, the controller/processor 390 may also use an acknowledgement (ACK) and/or negative acknowledgement (NACK) protocol to support retransmission requests for those frames.

In the uplink, data from a data source 378 and control signals from the controller/processor 390 are provided to a transmit processor 380. The data source 378 may represent applications running in the UE 350 and various user interfaces (e.g., keyboard). Similar to the functionality described in connection with the downlink transmission by the node B 310, the transmit processor 380 provides various signal processing functions including CRC codes, coding and interleaving to facilitate FEC, mapping to signal constellations, spreading with OVSFs, and scrambling to produce a series of symbols. Channel estimates, derived by the channel processor 394 from a reference signal transmitted by the node B 310 or from feedback contained in the midamble transmitted by the node B 310, may be used to select the appropriate coding, modulation, spreading, and/or scrambling schemes. The symbols produced by the transmit processor 380 will be provided to a transmit frame processor 382 to create a frame structure. The transmit frame processor 382 creates this frame structure by multiplexing the symbols with a midamble 214 (FIG. 2) from the controller/processor 390, resulting in a series of frames. The frames are then provided to a transmitter 356, which provides various signal conditioning functions including amplification, filtering, and modulating the frames onto a carrier for uplink transmission over the wireless medium through the antenna 352.

The uplink transmission is processed at the node B 310 in a manner similar to that described in connection with the receiver function at the UE 350. A receiver 335 receives the uplink transmission through the antenna 334 and processes the transmission to recover the information modulated onto the carrier. The information recovered by the receiver 335 is provided to a receive frame processor 336, which parses each frame, and provides the midamble 214 (FIG. 2) to the channel processor 344 and the data, control, and reference signals to a receive processor 338. The receive processor 338 performs the inverse of the processing performed by the transmit processor 380 in the UE 350. The data and control signals carried by the successfully decoded frames may then be provided to a data sink 339 and the controller/processor, respectively. If some of the frames were unsuccessfully decoded by the receive processor, the controller/processor 340 may also use an acknowledgement (ACK) and/or negative acknowledgement (NACK) protocol to support retransmission requests for those frames.

The controller/processors 340 and 390 may be used to direct the operation at the node B 310 and the UE 350, respectively. For example, the controller/processors 340 and 390 may provide various functions including timing, peripheral interfaces, voltage regulation, power management, and other control functions. The computer readable media of memories 342 and 392 may store data and software for the node B 310 and the UE 350, respectively. For example, the memory 392 of the UE 350 may store a tune-away module 391 which, when executed by the controller/processor 390, configures the UE 350 to implement a tune-away method according to aspects of the present disclosure. A scheduler/processor 346 at the node B 310 may be used to allocate resources to the UEs and schedule downlink and/or uplink transmissions for the UEs.

Some networks, such as a newly deployed network, may cover only a portion of a geographical area. Another network, such as an older more established network, may better cover the area, including remaining portions of the geographical area. In areas where a first network utilizing a first radio access technology (e.g., TD-SCDMA) is deployed, a second network utilizing a second radio access technology (e.g., Global System for Mobile Communications (GSM) or wideband code division multiple access (WCDMA) may also have a geographical presence.

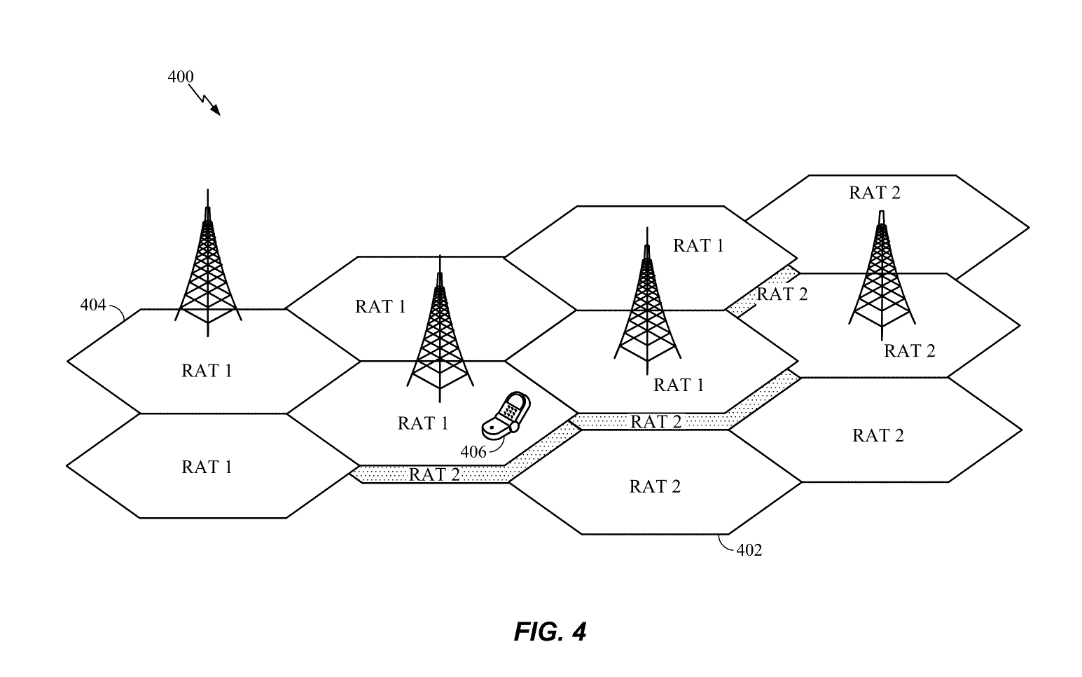

FIG. 4 illustrates coverage of a newly deployed network utilizing a first type of radio access technology (i.e., RAT-1), such as a TD-SCDMA network, and also coverage of an established network utilizing a second type of radio access technology (i.e., RAT-2), such as a GSM network. In this deployment of a network, a user equipment (UE) may be in the vicinity of the first RAT but continue to perform inter-radio access technology (inter-RAT) measurement of the second RAT. This measurement may be implemented for a cell or base station reselection procedure from the first RAT to the second RAT.

The geographical area 400 includes RAT-1 cells 404 and RAT-2 cells 402. In one example, the RAT-1 cells are TD-SCDMA cells and the RAT-2 cells are GSM cells. However, those skilled in the art will appreciate that other types of radio access technologies may be utilized within the cells. A user equipment (UE) 406 may move from one cell, such as a RAT-1 cell 404, to another cell, such as a RAT-2 cell 402. The movement of the UE 406 may specify a handover or a cell reselection.

Handover from a first radio access technology (RAT) to a second RAT may occur for several reasons. First, the network may prefer to have the user equipment (UE) use the first RAT as a primary RAT but use the second RAT simply for voice service(s). Second, there may be coverage holes in the network of one RAT, such as the first RAT.

Handover from the first RAT to the second RAT may be based on event 3A measurement reporting. In one configuration, the event 3A measurement reporting may be triggered based on filtered measurements of the first RAT and the second RAT, a base station identity code (BSIC) confirm procedure of the second RAT and also a BSIC re-confirm procedure of the second RAT. For example, a filtered measurement may be a Primary Common Control Physical Channel (P-CCPCH) or a Primary Common Control Physical Shared Channel (P-CCPSCH) received signal code power (RSCP) measurement of a serving cell. Other filtered measurements can be of a received signal strength indication (RSSI) of a cell of the second RAT.

The initial BSIC identification procedure occurs because there is no knowledge about the relative timing between a cell of the first RAT and a cell of the second RAT. The initial BSIC identification procedure includes searching for the BSIC and decoding the BSIC for the first time. The UE may trigger the initial BSIC identification within available idle time slot(s) when the UE is in a dedicated channel (DCH) mode configured for the first RAT.

### Tune-Away for Multi-sim Multi-Standby Devices

Aspects of the present disclosure are directed to a tune away method for a multiple subscriber identity module (SIM) multiple standby device from a first radio access technology (RAT) to a second RAT. For example, the multi-SIM multi-standby device may be a dual-SIM dual-standby user equipment (UE). The UE communicates with a first radio access technology (RAT) with a transmit chain and a receive chain. The UE then tunes the receive chain to a second RAT to monitor downlink communications or activities of the second RAT. The monitored activities of the second RAT may include paging, searching for signals, measurements, collection of system information, cell reselection and other downlink wireless communication activities. In one aspect of the disclosure, the UE transmits on the first RAT with the transmit chain, while tuned to the second RAT for reception. For example, the UE continues to perform uplink transmission on the first RAT when the UE tunes away to the second RAT to facilitate recovery of an original operation of the first RAT. Performing uplink transmission in this case, allows a base station to track the UE for downlink beam-forming. Such a method may operate in a time division duplex (TDD) network, such as TD-SCDMA.

The multi-SIM multi-standby device, such as the dual-SIM dual-standby (DSDS) UE, may connect to one network at a time for transmission or reception because there is only one RF for the UE, the UE can only communicate with one network while in the connected mode.

The multi-SIM multi-standby UE includes multiple SIM devices (e.g., SIM cards or virtual SIMs) for different implementations. For example, the DSDS implementation provides the ability to have two active SIM devices sharing only one RF device (e.g., transceiver or transmit/receive chain). Each SIM device includes full phone features that allow the UE to use a first SIM device for a first city and/or network operator and a second SIM device for second city and/or network operator. The use of the multi-SIM multi-standby UE, in this case, allows the UE to reduce roaming and long distance costs. The first SIM device may also be used for a first carrier or for personal use, while the second SIM device is used for a second carrier and/or for work/business. In other implementations, the first SIM device may be used for full telephone features while the other is used for data services. Further, the multi-SIM multi-standby UE allows users to switch to a second carrier while the current carrier is still active.

The multi-SIM multi-standby UE may have a single radio frequency (RF) chain, such as a single transmit/receive chain. When communications of a first RAT are in a current/original operation, such as dedicated channel (DCH) mode (i.e., without voice traffic) or connected mode with a first RAT, the multi-SIM multi-standby UE supports tuning away from the first RAT (e.g., TD-SCDMA) to a second RAT (e.g., GSM). Tuning away to the second RAT may be accomplished with little interruption to the original operation of the first RAT. When the UE is in the original operation of the first RAT, the UE periodically tunes away from the first RAT to the second RAT to monitor activities (e.g., a page) from the second RAT. In some implementations, if the UE detects a page from the second RAT when the UE is tuned away from the first RAT, the multi-SIM multi-standby UE suspends all operations of the first RAT and transitions to the second RAT. Otherwise, the UE returns to the first RAT and attempts to recover the original operation of the first RAT.

In some implementations, the UE may attempt to recover the original operation of the first RAT based on a duration of a tune-away gap. The tune-away gap may be a gap during a tune-away period when the UE is not monitoring activities of the second RAT. For example, if the tune-away period for monitoring a paging signal is 30 milliseconds, the gap may be a fraction of the tune-away period during which the UE is not monitoring for the paging signal. The tune-away gap may coincide with a period before or after the paging signal is identified. The duration of the tune-away gap may be monitored by a timer. In some implementations, the recovery of the original operation may be based on a comparison of the tune-away gap to other time parameters. For example, if the duration of the tune-away gap is less than a predefined time, T1, the UE restores a frequency, time tracking loop and uplink and downlink physical channels of the first RAT. In some implementations, the predefined time is sixty seconds.

If the duration of the tune-away gap is greater than the predefined time, T1, but less than a duration of a radio link failure timer, T313, the UE performs reacquisition of the original operation by resetting the frequency and timing tracking loops of the first RAT. The UE triggers a radio link failure when the radio link failure timer expires. If the duration of the tune-away gap is greater than the duration of the radio link failure timer but less than a duration of a radio access bearer (RAB) re-establishment timer T315, the UE performs radio link failure procedures. If the duration of the tune-away gap is greater than the RAB re-establishment timer, the UE performs a call release procedure. Because the recovery of the original operation of the first RAT is based only on the duration of the tune-away gap, the recovery may be inadequate.

One way to improve the recovery of the original operation of the first RAT is through beam-forming In some TDD RATs, such as TD-SCDMA, which include reciprocal uplink and downlink channels, beam-forming is an integral part of the determination of channel information for the recovery of the original operation. A base station of the first RAT determines downlink channel information of the first RAT based on uplink channel information. The channel information may be applied to downlink beam-forming without UE measurements and reporting.

To determine downlink beams (e.g., in TD-SCDMA), the base station tracks an angle of arrival measurement of communications from UEs in intervals (e.g., 5 ms intervals). For example, the base station receives uplink transmissions from a UE, determines a direction of arrival of the UE and produces relative phases on an antenna array to direct beams toward the UE. Because there is no uplink transmission from the first RAT when the UE tunes away from the first RAT, the UE is not tracked for downlink beam-forming purposes. Thus, when tuning back to the first RAT, the UE may fail to acquire downlink communication from the base station because the downlink beam is directed away from the UE. For example, the downlink beam may drift because of an inaccurate weight value assigned to the downlink beam. The likelihood of failure to acquire the downlink communication is increased with increased mobility of the UE and may even result in recovery failure.

In one aspect of the present disclosure, the UE continues to send uplink communications, such as uplink data or an uplink training sequence (e.g., special burst) to the first RAT when the downlink is tuned away from the first RAT to perform or monitor RAT activities of a different RAT. In one configuration, if there is no uplink data the UE transmits an uplink training sequence. Otherwise, the UE transmits the uplink data before the downlink returns to the first RAT.

To facilitate separate transmitting and receiving by the UE, the UE includes separate phase lock loops (PLLs) for downlink and uplink communications. For example, the UE monitors downlink communications of the second RAT (e.g., GSM paging signals) based on a first phase lock loop and transmits uplink communications (e.g., uplink special burst) based on a second phase locked loop. The first and second phase lock loops may be implemented on a same or different frequency. The separate PLLs give the single transceiver the ability to tune the downlink to one RAT while tuning the uplink to another RAT? For example, a first PLL is for the transmission (TX) part of a single transceiver, and a second PLL is for the receiver (RX) part of single transceiver.

In some aspects of the disclosure, the UE tunes the downlink from the second RAT to the first RAT to receive a synchronization shift (SS) command from the first RAT when there is a gap (e.g., tune-away gap) in monitoring activities of the second RAT. The UE collects and accumulates the synchronization shift commands received from the first RAT to determine the uplink transmission timing for the first RAT. For example, an uplink transmission timing for the first RAT can be adjusted based on the SS commands received during the tune away gap and/or based on a power control command (e.g., transmit power control). Because the SS command and the power control command are carried on an adjacent modulation symbol with SS, a short tuning back time period has little impact on activities of the second RAT.

Aspects of the present disclosure allow the base station of the first RAT to track the mobility of the UE based on an uplink channel estimation. The ability to track the mobility of the UE effectively improves recovery of the original operation of the first RAT.

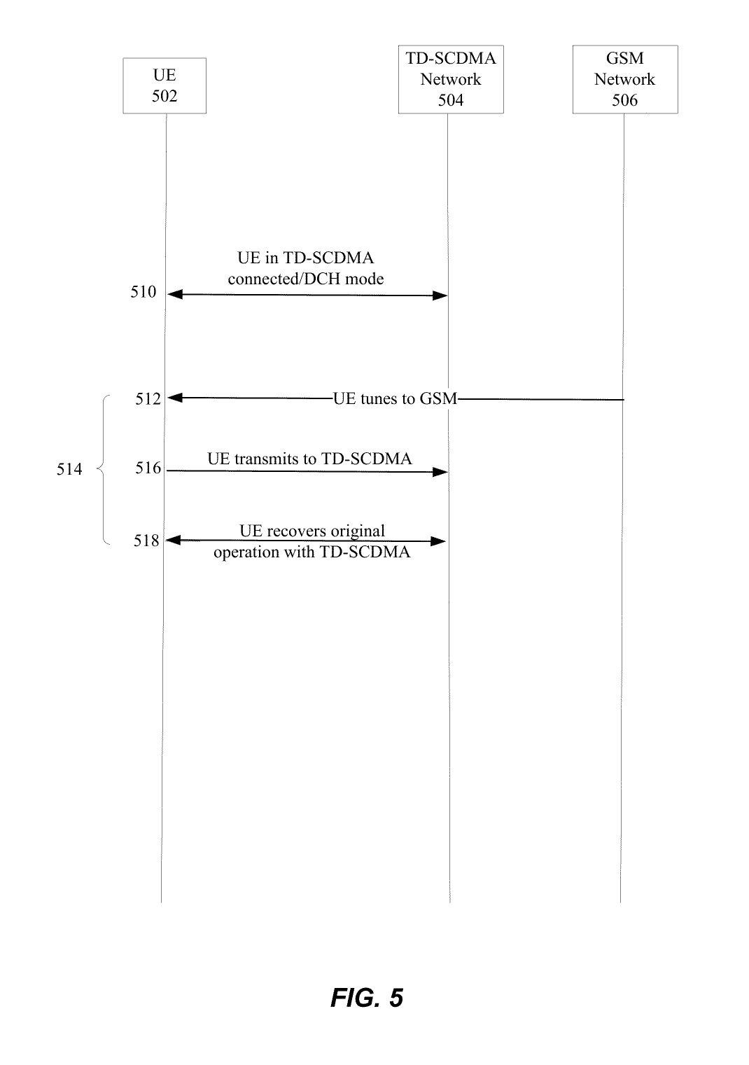

FIG. 5 illustrates an example of a call flow diagram for a tune away method for the multi-SIM multi-standby device in a wireless network. The communications of the tune away method are implemented with a single transmit/receive chain of the multi-SIM multi-standby device. The multi-SIM multi-standby device has two phase lock loops (PLLs).

At time 510, the UE 502 is in an original operation mode, such as a connected mode or a dedicated channel (DCH) mode with a network of a first RAT (e.g., TD-SCDMA). While in this mode, the UE 502 communicates with a TD-SCDMA base station 504. For example, the UE 502 transmits data to the TD-SCDMA base station 504 or receives data from the TD-SCDMA base station 504.

The UE 502 may tune its downlink tune away from the TD-SCDMA base station 504 to perform activities associated with a base station 506 of a second RAT. The downlink tune away is enabled by activation of a second PLL that will be associated with downlink communications. For example, at time 512, the UE 502 uses the second PLL to tune its receive chain away from the TD-SCDMA base station 504 to a GSM base station 506 to monitor downlink communications from the GSM base station 506. The UE 502 may be tuned away from the TD-SCDMA base station for a time period 514. While the UE receive chain is tuned to the GSM base station 506, the UE continues to transmit to the TD-SCDMA base station 504 with the first transmit chain, at time 516, using the first PLL. Allowing the UE 502 to continue to transmit on the TD-SCDMA base station 504 while tuned to the GSM base station 506 enables the TD-SCDMA base station 504 to estimate uplink information (e.g., timing) and configure downlink beam-forming based on the uplink information. At time 518, the UE recovers the original operation of the first RAT using the correctly formed downlink beam.

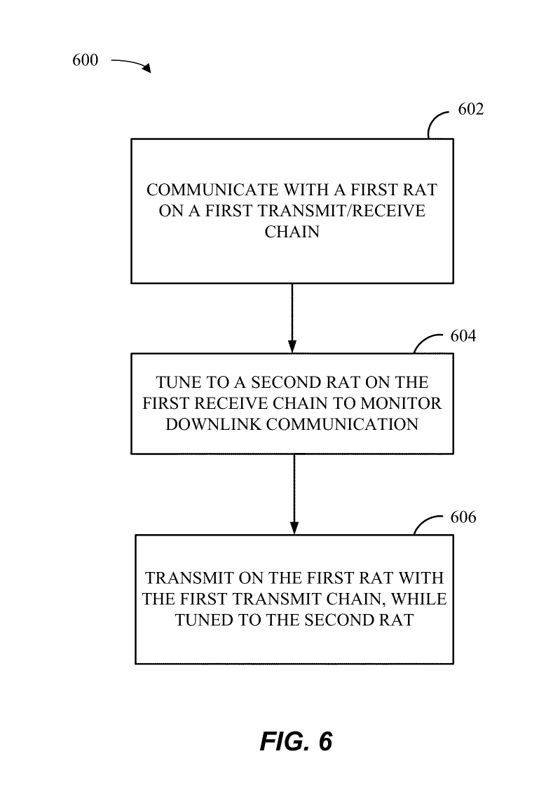

FIG. 6 shows a wireless communication method 600 according to one aspect of the disclosure. A UE communicates with a first radio access technology (RAT) on a transmit chain and receive chain, as shown in block 602. The UE then tunes its receive chain to a second RAT to monitor downlink communications, as shown in block 604. The UE also transmits on a first RAT with the transmit chain, while the receive chain is tuned to the second RAT, to enable a base station to estimate uplink information (e.g., timing) of the first RAT and to configure downlink beam-forming.

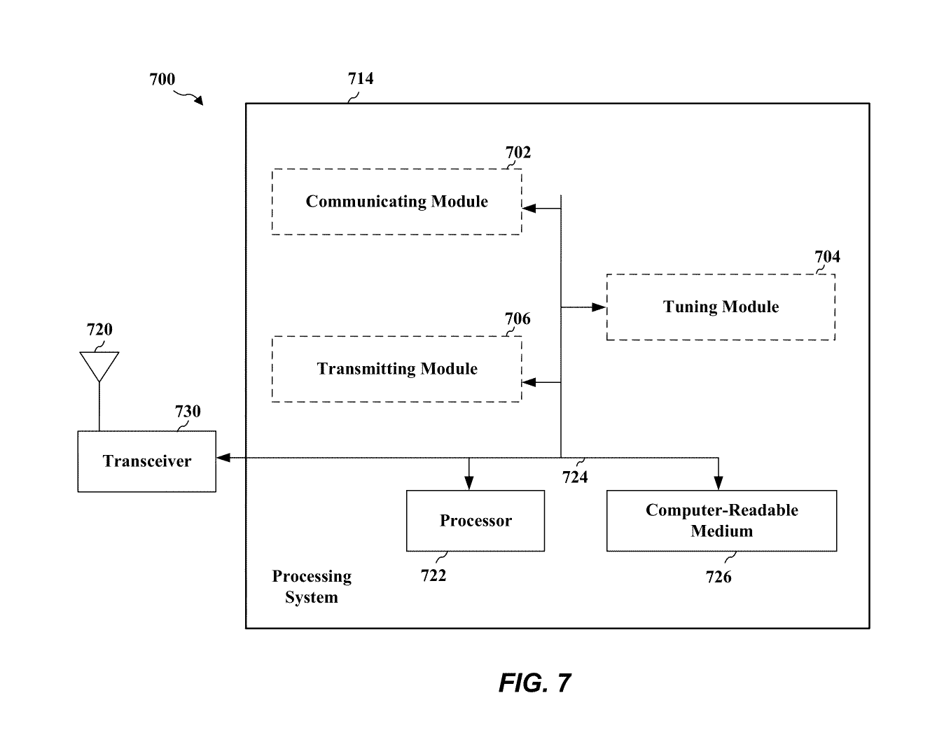

FIG. 7 is a diagram illustrating an example of a hardware implementation for an apparatus 700 employing a tune-away system 714. The tune-away system 714 may be implemented with a bus architecture, represented generally by the bus 724. The bus 724 may include any number of interconnecting buses and bridges depending on the specific application of the tune-away system 714 and the overall design constraints. The bus 724 links together various circuits including one or more processors and/or hardware modules, represented by the processor 722 the modules 702, 704, 706 and the non-transitory computer-readable medium 726. The bus 724 may also link various other circuits such as timing sources, peripherals, voltage regulators, and power management circuits, which are well known in the art, and therefore, will not be described any further.

The apparatus includes a tune-away system 714 coupled to a transceiver 730. The transceiver 730 is coupled to one or more antennas 720. The transceiver 730 enables communicating with various other apparatus over a transmission medium. The tune-away system 714 includes a processor 722 coupled to a non-transitory computer-readable medium 726. The processor 722 is responsible for general processing, including the execution of software stored on the computer-readable medium 726. The software, when executed by the processor 722, causes the tune-away system 714 to perform the various functions described for any particular apparatus. The computer-readable medium 726 may also be used for storing data that is manipulated by the processor 722 when executing software.

The tune-away system 714 includes a communicating module 702 for communicating with a first RAT on a first transmit/receive chain. The tune-away system 714 includes a tuning module 704 for tuning to a second RAT on the first receive chain to monitor downlink communications. The tune-away system 714 includes a transmitting module 706 for transmitting on the first RAT with the first transmit chain, while tuned to the second RAT. The modules may be software modules running in the processor 722, resident/stored in the computer readable medium 726, one or more hardware modules coupled to the processor 722, or some combination thereof. The tune-away system 714 may be a component of the UE 350 and may include the memory 392, and/or the controller/processor 390.

In one configuration, an apparatus such as a UE is configured for wireless communication including means for communicating. In one aspect, the communicating means may be the antennas 352/720, the receiver 354, the channel processor 394, the receive processor 370, the transmitter 356, the transmit processor 380, the controller/processor 390/722, the memory 392, the tune-away module 391, communicating module 702, the transceiver 730 and/or the tune-away system 714 configured to perform the communicating means. In another aspect, the aforementioned means may be a module or any apparatus configured to perform the functions recited by the aforementioned means.

The UE is also configured to include means for tuning. In one aspect, the tuning means may be the antennas 352/720, the receiver 354, the channel processor 394, the receive processor 370, the controller/processor 390/722, the memory 392, the tune-away module 391, communicating module 702, the tuning module 704, the transceiver 730 and/or the tune-away system 714 configured to perform the tuning means. In another aspect, the aforementioned means may be a module or any apparatus configured to perform the functions recited by the aforementioned means.

In one configuration, an apparatus such as a UE is configured for wireless communication including means for transmitting. In one aspect, the transmitting means may be the antennas 352/720, the transmitter 356, the transmit processor 380, the controller/processor 390/722, the memory 392, the tune-away module 391, communicating module 702, the transceiver 730 and/or the tune-away system 714 configured to perform the transmitting means. In another aspect, the aforementioned means may be a module or any apparatus configured to perform the functions recited by the aforementioned means.

Several aspects of a telecommunications system has been presented with reference to TD-SCDMA and GSM systems. As those skilled in the art will readily appreciate, various aspects described throughout this disclosure may be extended to other telecommunication systems, network architectures and communication standards. By way of example, various aspects may be extended to other UMTS systems such as W-CDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a non-transitory computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication with a multiple subscriber identity module (SIM), multiple standby user equipment (UE), comprising:
communicating with a first radio access technology (RAT), which is time division based, using a transmitter and a receiver, communicating with the first RAT comprising performing uplink transmission on the first RAT with the transmitter and/or receiving downlink communications on the first RAT with the receiver;
tuning the receiver from the first RAT to a second RAT and/or frequency to monitor downlink communications on the second RAT and/or frequency; and
continue performing the uplink transmission on the first RAT with the transmitter, while tuned to the second RAT on the receiver, the continued performance of the uplink transmission enables a base station to estimate uplink timing of the first RAT and a corresponding downlink beam based at least in part on an uplink transmission from the UE when the receiver is tuned away from the first RAT to the second RAT and/or frequency.

2. The method of claim 1, further comprising:
tuning the receiver from the second RAT to the first RAT to receive synchronization shift (SS) commands and/or power control commands, during a tune away gap when tuned to the second RAT; and
adjusting uplink transmission timing for the first RAT based on the SS commands received during the tune away gap.

3. The method of claim 2, further comprising adjusting the uplink transmission timing based at least in part on a power control command.

4. The method of claim 1, in which transmitting on the first RAT comprises transmitting an uplink training sequence when there is no uplink data for the first RAT or transmitting uplink data for the first RAT.

5. The method of claim 1, in which the UE has only a single transmission and receiver.

6. The method of claim 1, in which the UE comprises a first phase lock loop for uplink communications for the first RAT and a second phase lock loop for downlink communications for second RAT.

7. The method of claim 1, in which downlink communications for the second RAT comprises at least one of: monitoring paging, collecting broadcast system information, performing acquisition, and performing cell reselection.

8. An apparatus for wireless communication with a multiple subscriber identity module (SIM), multiple standby user equipment (UE), comprising:
means for communicating with a first radio access technology (RAT), which is time division based, using a transmitter and a receiver, communicating with the first RAT comprising performing uplink transmission on the first RAT with the transmitter and/or receiving downlink communications on the first RAT with the receiver;
means for tuning the receiver from the first RAT to a second RAT and/or frequency to monitor downlink communications on the second RAT and/or frequency; and
means for continuing performing the uplink transmission on the first RAT with the transmitter, while tuned to the second RAT on the receiver, the continued performance of the uplink transmission enables a base station to estimate uplink timing of the first RAT and a corresponding downlink beam based at least in part on an uplink transmission from the UE when the receiver is tuned away from the first RAT to the second RAT and/or frequency.

9. The apparatus of claim 8, further comprising:
means for tuning the receiver from the second RAT to the first RAT to receive synchronization shift (SS) commands and/or power control commands, during a tune away gap when tuned to the second RAT; and
means for adjusting uplink transmission timing for the first RAT based on the SS commands received during the tune away gap.

10. The apparatus of claim 9, in which the adjusting means further comprises means for adjusting the uplink transmission timing based at least in part on a power control command.

11. An apparatus for wireless communication with a multiple subscriber identity module (SIM), multiple standby user equipment (UE), comprising:
a memory; and
at least one processor coupled to the memory and configured:
to communicate with a first radio access technology (RAT), which is time division based, using a transmitter and a receiver, communicating with the first RAT comprising performing uplink transmission on the first RAT with the transmitter and/or receiving downlink communications on the first RAT with the receiver;
to tune the receiver from the first RAT to a second RAT and/or frequency to monitor downlink communications on the second RAT and/or frequency; and
to continue performing the uplink transmission on the first RAT with the transmitter, while tuned to the second RAT on the receiver, the continued performance of the uplink transmission enables a base station to estimate uplink timing of the first RAT and a corresponding downlink beam based at least in part on an uplink transmission from the UE when the receiver is tuned away from the first RAT to the second RAT and/or frequency.

12. The apparatus of claim 11, in which the at least one processor is further configured:
to tune the receiver from the second RAT to the first RAT to receive synchronization shift (SS) commands and/or power control commands, during a tune away gap when tuned to the second RAT; and
to adjust uplink transmission timing for the first RAT based on the SS commands received during the tune away gap.

13. The apparatus of claim 12, in which the at least one processor is further configured to adjust the uplink transmission timing based at least in part on a power control command.

14. The apparatus of claim 11, in which the at least one processor is further configured to transmit an uplink training sequence when there is no uplink data for the first RAT or to transmit uplink data for the first RAT.

15. The apparatus of claim 11, in which the UE has only a single transmission and receiver.

16. The apparatus of claim 11, in which the UE comprises a first phase lock loop for uplink communications for the first RAT and a second phase lock loop for downlink communications for second RAT.

17. The apparatus of claim 11, in which downlink communications for the second RAT comprises at least one of: monitoring paging, collecting broadcast system information, performing acquisition, and performing cell reselection.

18. A computer program product for wireless communication with a multiple subscriber identity module (SIM), multiple standby user equipment (UE), comprising:
a non-transitory computer-readable medium having program code recorded thereon, the program code comprising:
program code to communicate with a first radio access technology (RAT), which is time division based, using a transmitter and a receiver, communicating with the first RAT comprising performing uplink transmission on the first RAT with the transmitter and/or receiving downlink communications on the first RAT with the receiver;
program code to tune the receiver from the first RAT to a second RAT and/or frequency to monitor downlink communications on the second RAT and/or frequency; and
program code to continue performing the uplink transmission on the first RAT with the transmitter, while tuned to the second RAT on the receiver, the continued performance of the uplink transmission enables a base station to estimate uplink timing of the first RAT and a corresponding downlink beam based at least in part on an uplink transmission from the UE when the receiver is tuned away from the first RAT to the second RAT and/or frequency.

19. The computer program product of claim 18, in which the program code further comprises:
program code to tune the receiver from the second RAT to the first RAT to receive synchronization shift (SS) commands and/or power control commands, during a tune away gap when tuned to the second RAT; and
program code to adjust uplink transmission timing for the first RAT based on the SS commands received during the tune away gap.

20. The computer program product of claim 19, in which the program code further comprises program code to adjust the uplink transmission timing based at least in part on a power control command.
